(19) United States
(12) Patent Application Publication
(10) Pub. No.: US 2002/0097259 A1
(43) Pub. Date: Jul. 25, 2002

(54) System for compiling memories materials to automatically generate a memories product customized for a recipient

(75) Inventors: Tony B. Marshall, Shawnee, KS (US); Wesley D. Lindquist, Kansas City, MO (US); Laura S. Monsees, Kansas City, MO (US); Barbara J. Rich, Raytown, MO (US); Stan C. Rice, Lenexa, KS (US); Caroline J. Howe, Overland Park, KS (US); Brenda K. Althouse, Kansas City, MO (US); Stephen H. Chalson, Overland Park, KS (US)

Correspondence Address: PATTON BOGGS, PO BOX 270930, LOUISVILLE, CO, 80027, US

(73) Assignee: Hallmark Cards Incorporated

(21) Appl. No.: 09/751,196

(22) Filed: Dec. 29, 2000

(51) Int. Cl. G06F 12/00

(52) U.S. Cl. 345/738; 345/763

(57) ABSTRACT

The memories product generation system provides a customer with the capability to input and edit various memories materials for use in generating memories products. The customer also defines at least one topic that is used to organize the received memories materials and at least one “story”, which consists of a recipient's point of view of or interest in the memories materials. The memories product generation system then automatically organizes the received memories materials and integrates these materials with finishing touches, such as: background, borders, captions, titles, sentiments, dates, additional materials, animation, and the like. The memories product generation system identifies the various memories products that can be generated from the received memories materials and the customer can preview and edit these memories products prior to purchasing these memories products, each of which can be customized to correspond to the interests of a selected recipient.

### FIELD OF THE INVENTION

This invention relates to the field of memories products and, in particular, to a system for compiling memories materials to automatically generate a memories product.

### PROBLEM

It is a problem in the field of memories products to both process a large number of memories materials and use these memories materials to produce a quality memories product that is customized for a particular recipient. To produce a quality memories product requires creativity, time, organizational ability, tools and materials as well as the ability to manufacture the memories product.

One subset of memories products are the manual compilations of memories materials that an individual assembles, such as: a photograph album, a scrapbook, a family newsletter, a calendar, genealogy product, and the like, but these products are complicated to produce. While there are numerous craft workshops that teach an individual how to produce various types of memories products and there exists a significant market for materials to enable an individual to produce various types of memories products, only a few individuals have the time and resources (both physical and creative) to produce a quality product. In addition, the manual production of memories products is extremely labor intensive and this field lacks the tools to enable an individual to simply integrate various source materials into a finished memories product. Furthermore, some memories product finishing techniques are simply unavailable to the individual, since they require complex and expensive machinery to implement. One benefit of the manual production of the memories products is that the individual who is performing the work is typically familiar with the recipient of the memories product and can therefore personalize the memories product for that individual. The resultant memories product is therefore a unique work and reflects the creative and personal input of the individual. The production of a multi-media memories product presently represents a further degree of complexity and such products are beyond the capabilities of all but a few individuals.

Another subset of memories products are the professionally produced items, such as: wedding albums, photograph collections on CD-ROM, edited home videos, and the like. These memories products are simply higher quality assemblages of source materials and typically lack any personalization for the individual customer. The source materials provided by the customer or generated by the professional are simply mechanically collected and reproduced in a high quality output format. The professional who creates these memories products generally produces a plurality of identical items for the individual and these memories products typically lack much sentiment, much less a sentiment that is recipient-specific and insightful. Furthermore, some memories product finishing techniques are simply unavailable to the professional, since they require complex and expensive machinery to implement. Many of these memories products are expensive and therefore infrequently purchased by the average customer. There are also no multi-media memories products commonly available even in this segment of the market.

There is presently no simple system that would enable the individual who has a collection of source materials to process a large number of memories materials and produce a quality memories product that is customized for a particular recipient.

### SOLUTION

The above described problems are solved and a technical advance achieved by the present system for compiling memories materials to automatically generate a memories product that is customized for a particular recipient, termed “memories product generation system” herein. The memories product generation system provides a customer with the capability to input and edit various memories materials for use in generating memories products, which can be electronic or physical in form. The customer also defines at least one topic that is used to organize the received memories materials and at least one “story”, which consists of a recipient's point of view or interest in the memories materials. The memories product generation system then automatically organizes the received memories materials and integrates these materials with finishing touches, such as: background, borders, captions, titles, sentiments, dates, additional materials, animation, and the like. The memories product generation system identifies the various memories products (“virtual memories products”) that can be generated from the received memories materials and the customer can preview and edit these virtual memories products at any time. Prior to purchasing a memories product, the customer can customize the virtual memories product to correspond to the interests of a selected recipient, and store a number of virtual memories products and/or versions of virtual memories products for future use. The customer can make changes to selected ones of the stored virtual memories products and then select other virtual memories products for purchase. Once the customer finalizes the customer's order, a memories product is produced, as defined by the selected virtual memories product. The customer can use previously stored virtual memories products to simply order additional memories products, exactly the same as previously ordered.

### BRIEF DESCRIPTION OF THE DRAWING

FIGS. 1A and 1B illustrate in block diagram form the overall architecture of the present memories product generation system and a data communication environment in which it is operational;

FIGS. 2-4 illustrate in flow diagram form the operation of the present memories product generation system;

FIGS. 5-10 illustrate the content of typical screen displays produced by the present memories product generation system;

FIG. 11 illustrates schematically the typical architecture of a story;

FIG. 12 illustrates in flow diagram form an overview of the operation of the memories product generation system;

FIG. 13 illustrates in flow diagram form the operation of the Choose Product option in the present memories product generation system; and

FIGS. 14 and 15 illustrate in flow diagram form the operation of the present memories product generation system in routing a virtual memories product to one or more individuals for their review and input.

### DETAILED DESCRIPTION

Glossary

The terms used in this description are defined below to ensure that the proper import is ascribed to these terms and the usage of these terms is therefore unambiguous.

Memories Product—A memories product consists of any product that contains some personalization that is provided and/or controlled by a customer. Memories products include a vast array of products and include, but are not limited to: printed materials: social expression cards, holiday cards, invitations, memories albums, calendars, genealogy products, frame-worthy prints, posters, T-shirts, tablecloths, napkins, wrapping paper, beverage containers, and the like; or audio-visual materials: screen savers, computer display wallpaper, video tape, DVD video disc, virtual album that enables the recipient and/or sender to interactively participate in a simulation and/or presentation, and the like.

Virtual Memories Product—A virtual memories product is the draft version of a memories product that is produced by the memories product generation system, interacting with a customer and using the customer's memories materials. The virtual memories product can be considered a template that can be used to produce the tangible (electronic or physical form) memories product that is delivered to recipients.

Memories Materials—Memories materials consist of data that is provided to create a memories product. The memories materials can be of various formats: video, audio, data, graphics, animation, and the like, and can be obtained from numerous sources: the customer, external sources, or provided/generated by the memories product generation system.

Terminal Equipment—The device of choice that customers use to access and interact with the memories product generation system. These devices are electronic in nature and can range in complexity, functionality and portability, including, but not limited to: a personal computer, hand held computing device, cellular communication device, or other data interface device. The terminal equipment can be a device owned by the customer, or can be a device located in a retail establishment and operated by the personnel employed by the retail establishment. In this case, the customer can work one-on-one with the personnel employed by the retail establishment to design and order the memories product(s).

Customer Terminal Equipment and Communications Environment

The customers are typically equipped with a personal computer T1, T2 hand held computing device, cellular communication device T3, wireless computer device T4, or other data interface device, collectively termed “terminal equipment” herein. The data communication connection between the customer's terminal equipment T1 and the fulfillment center 120 can be via a data communication medium (such as the Internet), termed IP Network 103 herein, using the well known personal computer modem and browser technology available at the customer's terminal equipment T1. The customer's terminal equipment is generally served by the Public Switched Telephone Network (PSTN) which consists of a plurality of Local Exchange System 101, 102 interconnected via an Interexchange Carrier Network 100. The physical connection that supports this data communication connection is typically effected from customer's terminal equipment T1 through the Local Exchange System 102 of the Public Switched Telephone Network (PSTN) to the data communication medium, IP Network 103, via an Internet Service Provider 112 which is also connected thereto. The IP Network 103 is also connected to a Local Exchange System 101 via Internet Service Provider 111 which serves the gateway 122 of the fulfillment center 120. Alternatively, the customer's terminal equipment, in the case of cellular communication device T3, or wireless computer device T4, are connected via the Mobile Telecommunications Switching Office (MTSO) 104 to the Public Switched Telephone Network (PSTN).

Fulfillment Center

The fulfillment center 120 is connected to at least one data communication medium, such as IP Network 103, to thereby enable customers to obtain data communication connections with the fulfillment center 120, as described in more detail below. The resources illustrated herein are selected for the purpose of illustrating the concept of the fulfillment center 120 and are not intended to limit the applicability of this concept to other network implementations. Fulfillment center 120 consists of a server 121 which is connected to the IP Network 103 via a gateway 122 that comprises the firewall which protects the fulfillment center 120 from unauthorized access and also implements the functionality to communicate with Internet Service Provider 111. The fulfillment center 120 also includes a message system 122A that is used to generate and transmit e-mail messages to customers and to also transmit any electronic greetings that are generated by the fulfillment center 120 to the designated recipient.

The fulfillment center 120 includes a plurality of databases A-D which include: Order History, Users, Addresses, Memories Materials (123-126), some of which can optionally or in part be resident on the customer's terminal equipment, and production devices, such as a production system 128 which processes customer orders and implements credit card billing while also including order production equipment to produce social expression products. The production system 128 is typically designed to produce a particular class of product, although in many cases it is adapted to produce multiple types of products. For example, in the case of invitations, the invitations can be implemented in many different forms. Invitations range from e-card invitations and simple printed cards to printed cards that are processed with extensive finishing features, including, but not limited to: embossing, foil, custom printing, natural writing signatures, images, photographs, and the like. The more features included in the invitation, the more complex the manufacturing process required to produce the invitation. Therefore, production system 128 can be equipped with high quality production equipment to serve this need.

As an alternative to this above-noted centralized system, is the use of a distributed architecture, which includes a remotely located component(s) of the memories product generation system. For example, a retail establishment can implement a functionality 130 that includes the memories product generation system 129B and an associated Memories Materials database 134 to thereby enable the customer, typically with the assistance of a retail clerk, to create memories product(s) via terminal equipment 133. The resultant memories product(s) can be produced locally, or exported via gateway 132 to fulfillment center 120 for production. The retail establishment can be a memories product vending establishment, such as a card store, or a photo kiosk at an amusement park, or any such establishment.

Architecture of the Memories Product Generation System

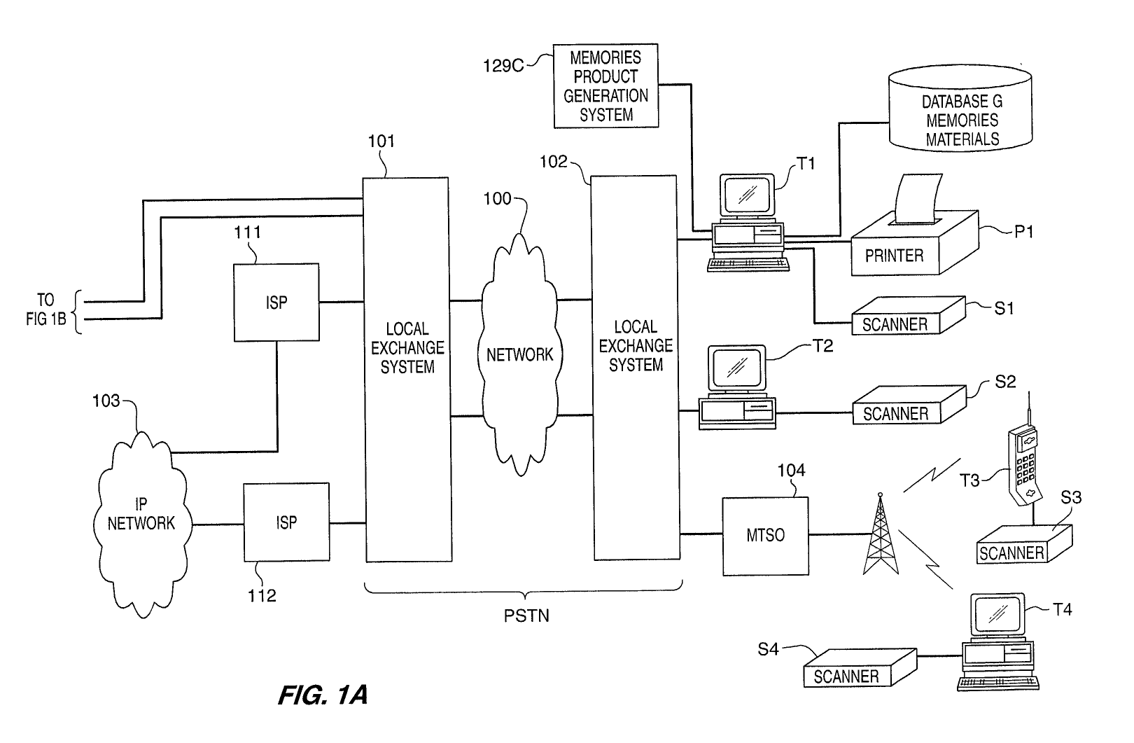

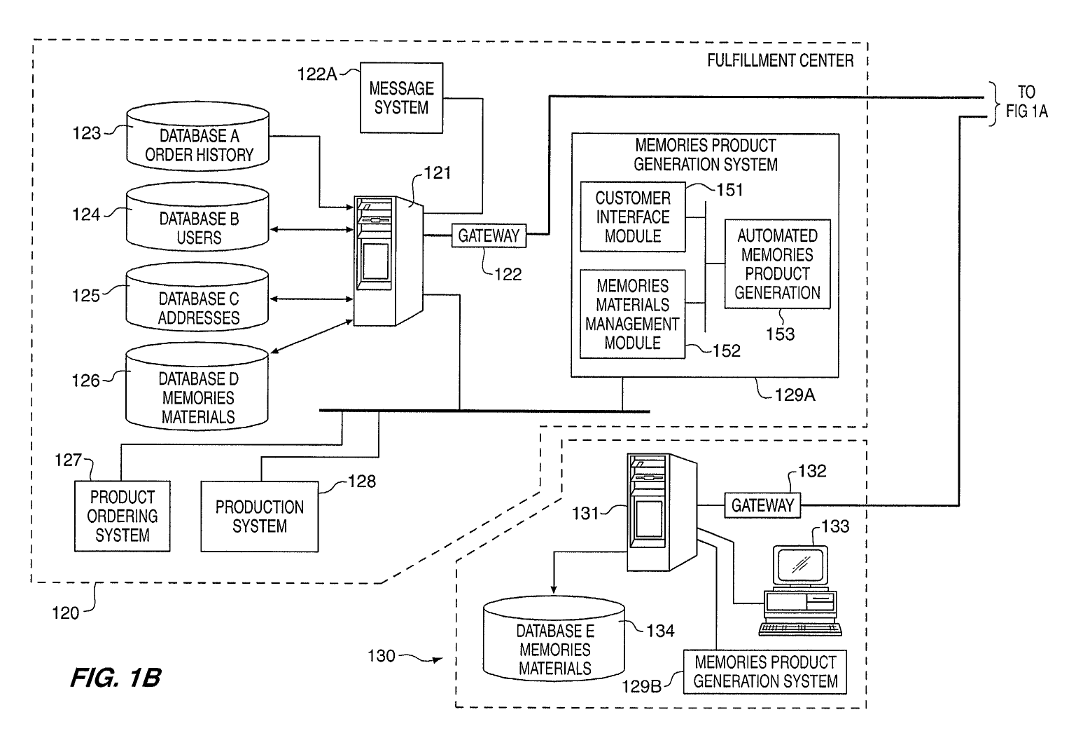

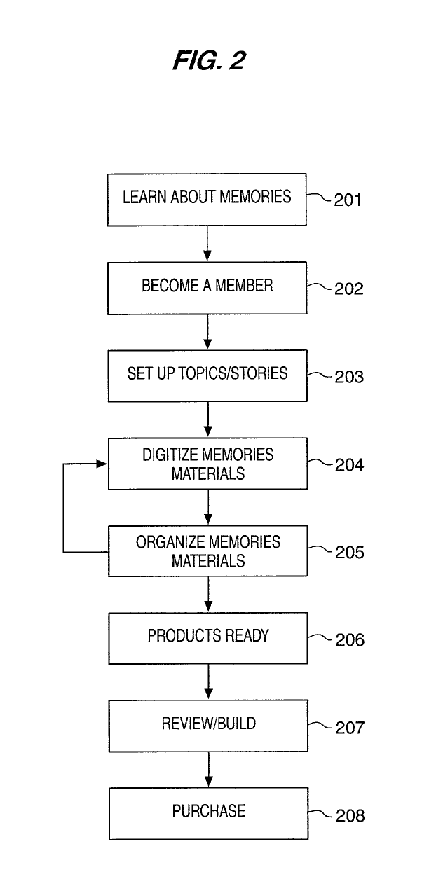

FIGS. 1A & 1B illustrate in block diagram form the overall architecture of the present memories product generation system and a typical environment in which it is operational and FIGS. 2-4 illustrate in flow diagram form the operation of the present memories product generation system. The architecture of the memories product generation system described herein represents a typical implementation of the memories product generation system and its operating environment and is not intended to limit the scope of the underlying concept as defined in the enclosed claims.

The memories product generation system 129A is shown as being an integral part of the fulfillment center 120, although the memories product generation system 129B can also be part of another stand alone system 130 that is connected for example to the data communication medium, IP Network 103, and accessible to the fulfillment center 120 via the data communication medium, IP Network 103, or memories product generation system 129C can also be a part of (or connected to) the customer's terminal equipment T1. The location and apparatus used to output the memories product is also subject to design choice and for the purpose of this description, the memories product output device is considered to be production system 128. There are many configurations of the memories product generation system that can be envisioned, and the embodiment disclosed herein simply represents one of these configurations that illustrate the concepts of the invention. Therefore, for the purpose of simplicity of description, only one (129A) of these various embodiments is described herein, although it is obvious that the other embodiments can be used to produce memories products, in a manner that is analogous to the method as described herein. In particular, the following description envisions the use of existing components in the fulfillment center 120 to implement the disclosed functionality. The memories product generation system 129A includes, in whole or in part or operates in conjunction with: the Addresses Database C (125), message system 122A, Memories Materials Database 126, product ordering system 127, production system 128 and the like, in implementing the memories product generation functionality. The memories product generation system 129A further includes a customer interface module 151 for managing the interface with the customer, a memories materials input module 152 that functions to receive memories materials from any of a number of sources, and an automated memories product generator 153 that comprises the intelligence that assembles the memories materials for a customer into the memories product(s), with the proper selection of creative materials and product finish.

Memories Materials Library

The customer defines a set of memories materials as well as data that identifies at least one topic of interest that is relevant to the customer and recipients of the memories products. The memories materials can comprise any type of data, and the example of images, in the form of photographs, is used herein to illustrate the operation of the memories product generation system 129A. The memories materials can include various types of media: audio, visual, graphics, animation, which can be automatically combined by the automated memories product generator 153 of the memories product generation system 129A into an integrated memories product. The memories products can consist of any product that contains some personalization that is provided and/or controlled by a customer. Memories products include a vast array of products and include, but are not limited to: printed materials: social expression cards, holiday cards, invitations, memories albums, frame-worthy prints, calendars, genealogy products, posters, T-shirts, tablecloths, napkins, wrapping paper, beverage containers, and the like; or audio-visual materials: screen savers, computer display wallpaper, video tape, DVD video disc, virtual album that enables the recipient and/or customer to interactively participate in a simulation and/or presentation of memories materials, and the like.

The memories product generation system 129A can provide additional memories materials from internal databases or externally located databases to supplement and complement the memories materials provided by the customer. For example, the memories product generation system 129A can provide historical data, such that entry of relevant date and location information by the customer results in the retrieval of historical data relating to the era in which the recipient was living, or the date input by the customer, or the events taking place in a company, or specific topic events relevant to the recipient's profile, or recipient's family, and the like.

The customer can input audio materials, such as narration, audio recordings, music, and the like. The audio input is coordinated with the visual materials in the memories product, and the coordination can be effected during the customer's review of the proposed memories product.

Furthermore, the memories product generation system 129A can store and/or retrieve profile data indicative of the interests and characteristics of the customer and/or a plurality of recipients. Thus, the customer can provide the memories product generation system 129A with information, in response to queries, relating to the identity of a recipient for the memories product(s) to thereby obtain the data necessary for the automated memories product generator 153 to customize the memories product(s) for the identified recipient, even where the recipient is the customer. The recipient profile data can include personal data that characterizes the recipient, such as: date of birth, residence, ethnic background, occupation, relation to the customer, and the like, as well as personal data that defines recipient-unique characteristics, such as: hobbies, favorite sports teams, and the like. This recipient-specific data is correlated with the memories materials, which are characterized by the customer so that their content and relevance to a recipient can be determined.

Characteristics of a Story

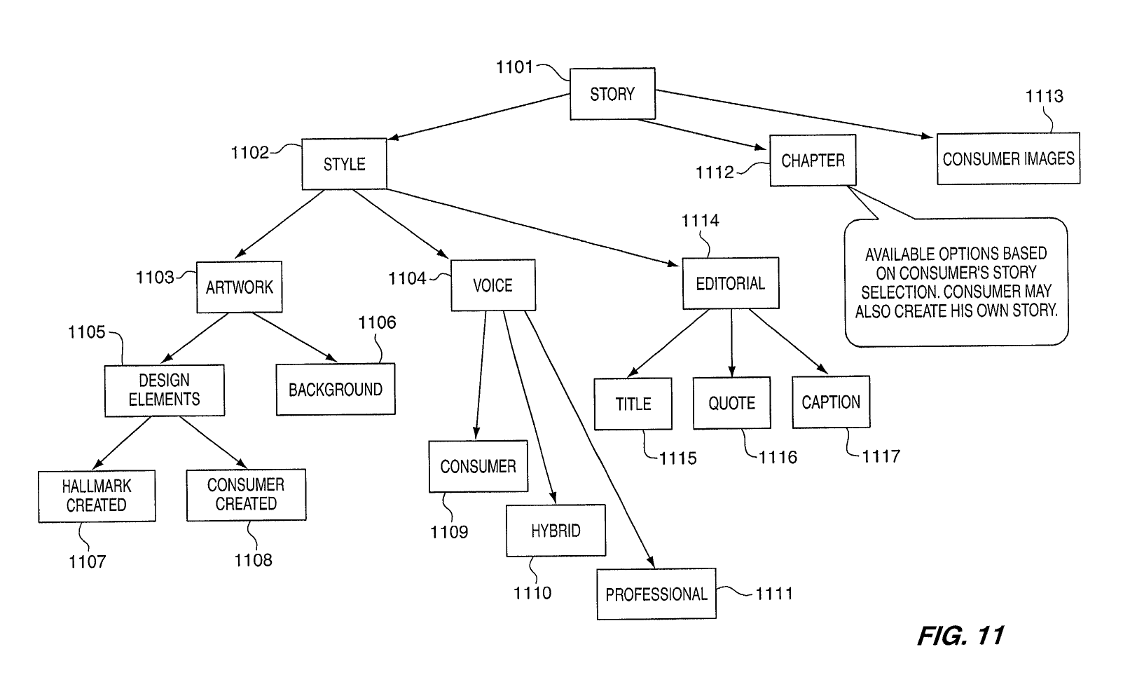

FIG. 11 illustrates schematically the typical architecture of a story. Relevant content is placed in the memories product(s) as a function of the customer selected story and style selected. Therefore, options are automatically created by the memories product generation system 129A and presented to the customer for their selection. Images are automatically placed in the layout of the selected memories product(s). Locations of content in the memories product(s) are automatically selected by the memories product generation system 129A using creative techniques embodied in the automated memories product generator 153 to attract the customer and the recipient and keep their attention during the memories product presentation. Content placement is balanced by the automated memories product generator 153 for each memories product layout. These operations are part of the story paradigm described herein as an embodiment of the memories product generation system 129A.

The story 1101 represents a theme that the customer selects to be representative of the content of the memories product(s). The story contains multiple components, including the customer images 1113 (memories materials), chapters 1112, which represent various subelements of the story and style 1102, which is the particular presentation mode and focus of the story. The style 1102 is itself composed of artwork 1103, optional audio content 1104 and editorial content 1114. The artwork 1103 consists of design elements 1105, which are either retrieved from a library of design elements, such as those offered 1107, or created by the customer 1108. The artwork 1103 also includes a background component 1106 which represents the unifying artwork on which the other components are overlaid. The audio content 1104 can contain customer generated segments 1109, professionally generated segments 1111, or hybrid segments 1110. Similarly, the editorial content 1114 can comprise title(s) 1115, quote(s) 1116, caption(s) 1117. Thus, the story 1101 is a combination of numerous elements, potentially drawn from numerous sources and initially automatically composed by the automated memories product generator 153 in the customer selected memories product(s).

Customer Interface Module

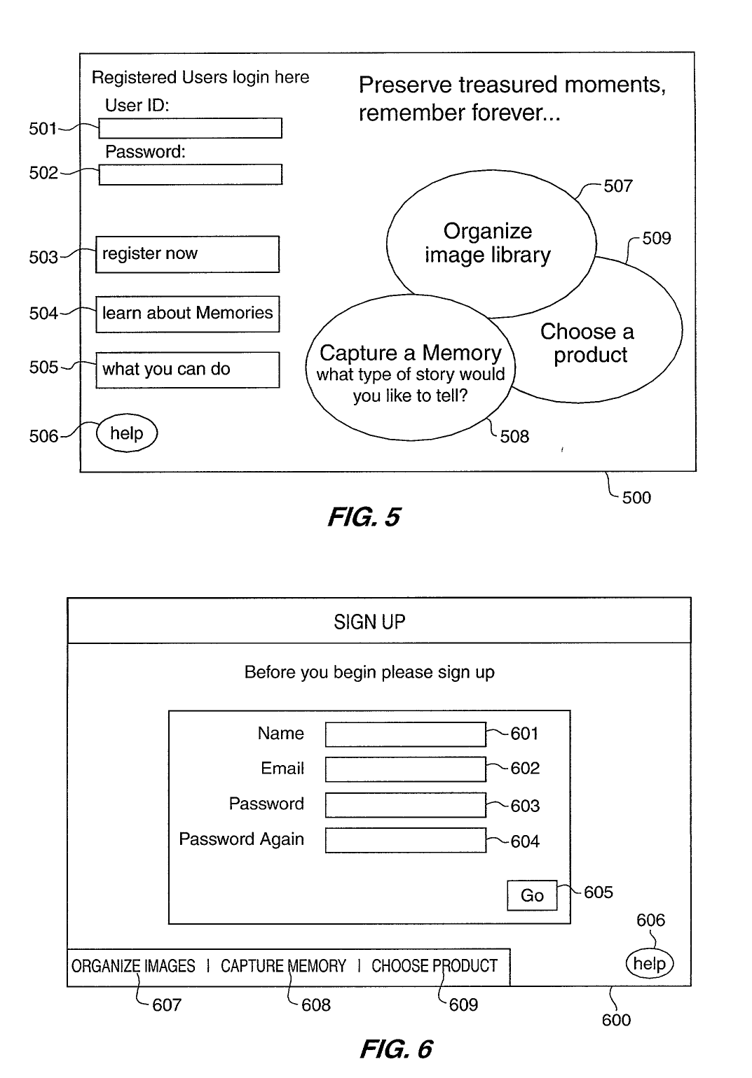

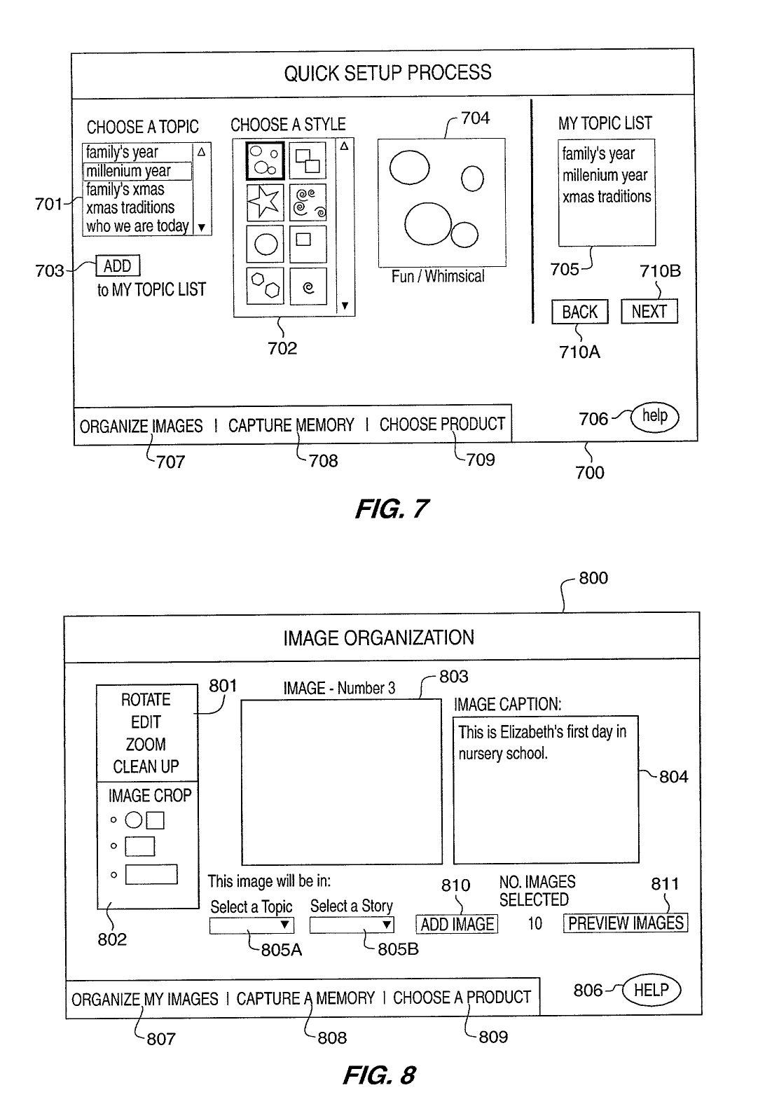

The customer interface module 151 is implemented via a guided graphics interface system, and the memories materials previously input by the customer are available via the customer interface module 151 as shown in the screen displays of FIGS. 5-10 and as described below. The memories product generation system 129A stores memories materials, virtual memories products, uploads, downloads or transfers memories materials via access to on-line repositories of memories materials in the Memories Materials Database 126, via the operation of the customer interface module 151 and under the control of the customer. The memories materials can be transferred in small groups, large batches or electronic transfer, with the format of the memories materials data being dynamically converted as the requirements of the memories product changes. The customer interface module 151 includes a built-in spell checker, word filter, image filter, and the like to ensure the production of a quality memories product for the customer.

There are a number of general navigation tools that remain constant throughout the operation of the memories product generation system 129A. These include the “Home” tool, which causes the customer interface to return to the entry screen display. The activation of the “Logout” tool results in the customer exiting the memories product generation system 129A. The “Project” tool, when activated, checks the status of the virtual memories product(s) creation. The “Profile” tool enables the customer to access the customized data that represents the interests of the customer and/or recipient(s). The “Image Bank” tool provides the customer with access to the collection of memories material that are available for use. The “Contact” tool provides information that identifies how the customer can obtain help from a customer support facility and who to ask for help. The “Help” tool is a context sensitive tool that initially provides the best choices for the customer, based on the present screen display and data entries, and enables the customer to perform a keyword search of help topics at any time.

Operation of the Memories Product Generation System

FIGS. 2-4 illustrate in flow diagram form the operation of the present memories product generation system 129A and FIGS. 5-10 illustrate the content of typical screen displays produced by the memories product generation system 129A. The flow charts of FIGS. 2-4 illustrate various options typically used for the operation of the memories product generation system: Standard, Save as You Go, Event Driven, respectively, to enable a customer to produce a memories product. The first option, Standard, is described herein with respect to the flow chart of FIG. 2 in the context of the customer accessing fulfillment center 120 via the data communication medium, IP Network 103, to activate memories product generation system 129A resident in the fulfillment center 120, using the customer's memories materials stored in the Memories Materials Database 126.

At step 201, the customer, once connected to the memories product generation system 129A, receives an initial screen display 500, such as that shown in FIG. 5 from customer interface module 151. This screen display 500 provides the customer with a number of options, as a function of the customer's familiarity with the memories product generation system 129A and whether the customer is a registered user of memories product generation system 129A. If the customer is a registered user, then the customer can provide their User ID in field 501 and their Password in field 502 to register with the memories product generation system 129A. In response to the data input in fields 501, 502, the memories product generation system 129A compares the data entries with the list of registered users stored in Database B, the Users Database 124, and performs a standard user authentication process to thereby enable the customer to proceed with the memories product generation. The authenticated customer can select from a number of options presented on screen display 500, such as Organize Images 507, Capture Memory 508, Choose Product 509, which options are described below. The Help option 506 offers the customer the option for a demonstration of the product creation, a list of frequently asked questions and any other pertinent topics related to this page and the opportunity to perform a word search of any of the topics listed in the help library.

However, for the sake of illustration, assume that this customer is not a registered user of the memories product generation system 129A. In this case, the customer can select the options “Learn About Memories” 504 or “What You Can Do” 505 to obtain a predetermined set of information that describes the operation of the memories product generation system 129A and its various features. This information is not described herein, and comprises a typical set of system descriptive materials as is well known in the art. If the customer accesses either or both of options 504, 505, they can return to screen display 500 by clicking on an appropriately designated option button displayed on these screen displays (not shown).

Assume that the customer wishes to become a registered user of the memories product generation system 129A. At this juncture, the customer clicks on the option button “Register Now” 503 to proceed to step 202 and is presented with screen display 600 of FIG. 6 by the memories product generation system 129A. The screen display 600 presents the customer with a standard set of options to enroll as a registered user of the memories product generation system 129A. The customer is presented with data entry fields 601-604, where the customer is requested to provide their “name”, “e-mail address”, a customer selected “Password”, and a repetition of the customer selected password, respectively. This standard customer registration process is activated when the customer clicks on the “Go” option button 605 to submit the data entries to thereby establish an account with the memories product generation system 129A. The memories product generation system 129A than creates a user entry in Database B-Users Database 124 for this customer. The customer is also provided with the standard “Help” option button 606 to enable the customer to obtain on-line assistance in the registration process or access a list of frequently asked questions and any other pertinent topics related to this display and the opportunity to perform a word search of any of the topics listed in the help library. The options: Organize Images 607, Capture Memory 608, Choose Product 609 are also presented on screen display 600.

If the customer selects the “Organize Images” option 607 and the customer has already created a virtual memories product, the customer is immediately transferred to the display screen shown in FIG. 8 and is presented with the queue of identified and available images, as described below. If a previous virtual memories product has not already been created, the customer is routed to the “Choose Product” option as there are no images to organize and nothing in the virtual memories product library.

If the customer selects the “Capture Memory” option 608, the customer is prompted with a list of typical situations/events for which they wish to prepare a memories product. In exercising this option, the memories product generation system 129A is focused on a theme or a particular situation/event. The customer is presented various options and is guided through the selection process. The customer also has the option to create their own definition of a situation/event. The final choice that the customer makes following this option is the memories product(s) desired to be produced.

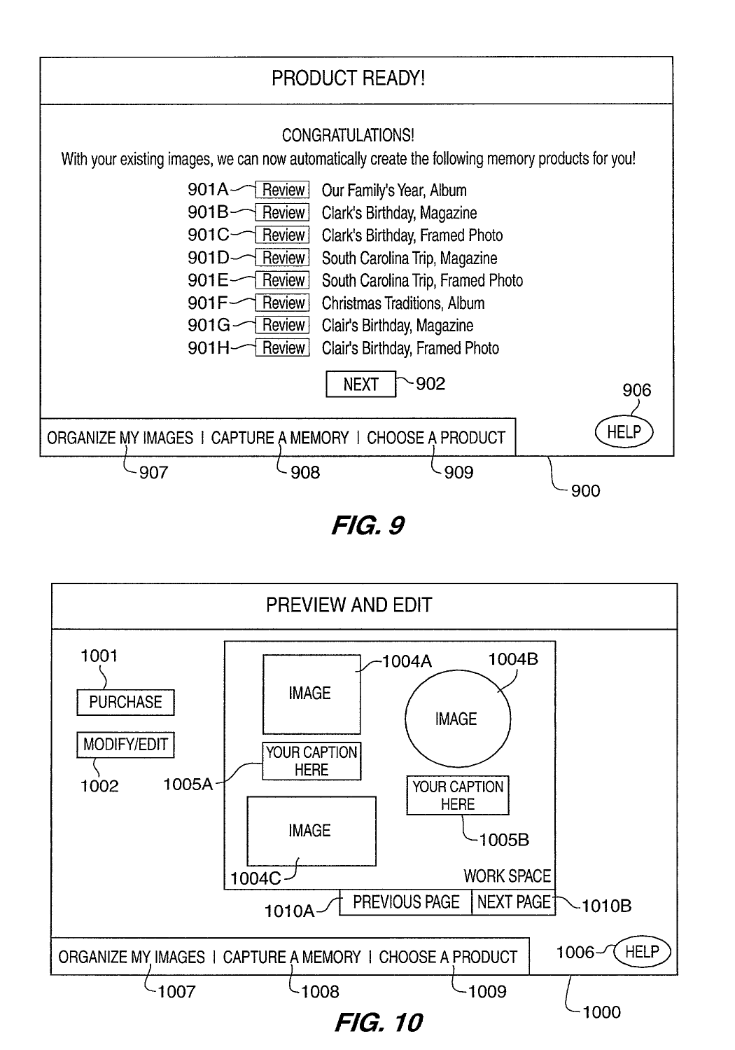

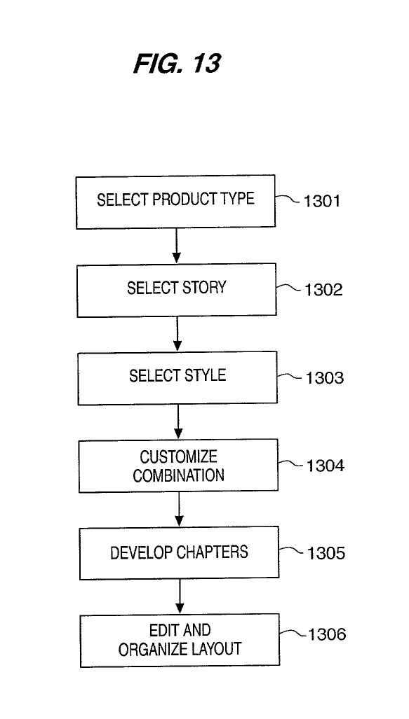

If the customer selects the “Choose Product” option 609, the customer is directed to a screen similar to FIG. 9. The focus of this option is that the customer wants to create a memories product. The customer is provided information regarding memories product options and requirements. The memories product created using this option has multiple themes within the memories product. The exercise of the “Choose Product” option follows the flow chart of FIG. 13, which illustrates in flow diagram form the operation of the “Choose Product” option in the present memories product generation system. In particular, the customer at step 1301 is prompted to select a type of memories product from a list of standard and/or customer defined memories products types. Once this initial selection is completed, the memories product generation system advances to step 1302 where the customer is prompted to select a story from a list of standard and/or customer defined stories. The memories product generation system then advances to step 1303 where the customer is prompted to select a style from a list of standard and/or customer defined styles. The memories product generation system advances to step 1304 where the customer is enabled to customize the combination of style and story that has been selected. The memories product generation system advances to step 1305 where the customer is prompted to develop chapters of the story to further refine the focus of the memories product. The memories product generation system then advances to step 1306 where the customer can edit and organize the layout of the memories product that has been created by the memories product generation system.

Registration Completed

Once the customer subscription data is processed by the memories product generation system 129A, with the possibility of intervening screen displays (not shown) to confirm the customer's registration, the customer registration process advances to step 203 where the customer is presented with screen display 700 to enable the customer to set up topic of interest, with a style for each of the plurality of topics to thereby enable automated memories product generator 153 to architect memories product(s) for the customer and/or recipient(s). The screen display 700 provides the customer with a number of options which the customer can define: the customer selects a topic from the list of standard topics presented in list display 701. Each topic selected by the customer activating option button “ADD” 703 is displayed in field 705 to thereby enable the customer to view the collection of topics selected. In this example, the customer has selected three topics: family's year, millennium year, xmas traditions. The customer can also select a style from the list of styles displayed in field 702 and the memories product generation system 129A automatically selects titles, borders, backgrounds, graphics, stories and placement of memories materials as noted above, as components of a story. The memories product generation system 129A selects number of memories materials per frame/page and can suggest how many memories products can be produced from the collection, if any, of memories materials stored for this customer. The product can include animation within the memory frame and/or between media frames.

The customer can retrace their navigation of this site from screen display 700 by activating the “BACK” button option 710A or proceed with the next step of the memories product generation process by activating the “NEXT” option button 710B to proceed to step 204, where the customer digitizes memories materials. The customer is also provided with the standard “Help” option button 706 to enable the customer to obtain on-line assistance, a list of frequently asked questions and any other pertinent topics related to this display and the opportunity to perform a word search of any of the topics listed in the help library. The options: Organize Images 707, Capture Memory 708, and Choose Product 709 are also presented on screen display 700 and are described above with reference to FIG. 6.

At step 204, the customer can upload, download or otherwise transfer memories materials, such as digital/digitized images or memories materials input via scanner S1, digital camera S2, a microphone S3 for voice input (or phone) or a digital video camera S4 attached to the customer's terminal device T1. The memories materials can be input from the terminal device T1, typically located at the customer's home, or scanned elsewhere and forwarded to the customer's home, or scanned at home and forwarded elsewhere, or scanned elsewhere and sent from elsewhere. These options are noted in FIG. 1A by the inclusion of “Scanner S2, S3, S4” therein to represent the fact that these terminal devices can be equipped with a scanner, digital camera, a microphone for voice input (or phone) or a digital video camera, all collectively termed “Scanner” on FIG. 1A for simplicity of illustration. The memories materials can also be linked to the memories product generation system 129A from an external database, either stored at the present time or dynamically generated and stored in the external source. The customer manages the memories materials portfolio by parsing the set of memories materials into at least one story and associates the story with a corresponding topic of interest.

At step 205, the customer can organize the memories materials using the screen display 800 as shown on FIG. 8. Each memories material is displayed seriatim in display field 803 and the customer has control of editing the display via the capabilities provided in lists 801 and 802, where the customer can “Rotate”, “Edit”, “Zoom”, “Clean-Up”, or crop the image using various shapes and aspect ratios. The customer can also create a caption via data entry field 804. The topic and story are selected via fields 805A, 805B, respectively. The memories product can comprise a product that morphs as a function of the recipient's identity, with the customer being a member of the class of recipients. Each page can represent a period of time, a specific event, specific individuals or any combination thereof. The recipient's profile can be stored or accessed from a remote site. The customer's profile can be dynamically and passively determined or can be crafted via the use of psychographic questions to automatically populate the customer's profile and thence the resulting memories product. The memories product can be in any media and any format, either printed, or electronic in form. The memories product generation system 129A automatically integrates various artifacts into various personalized memories products.

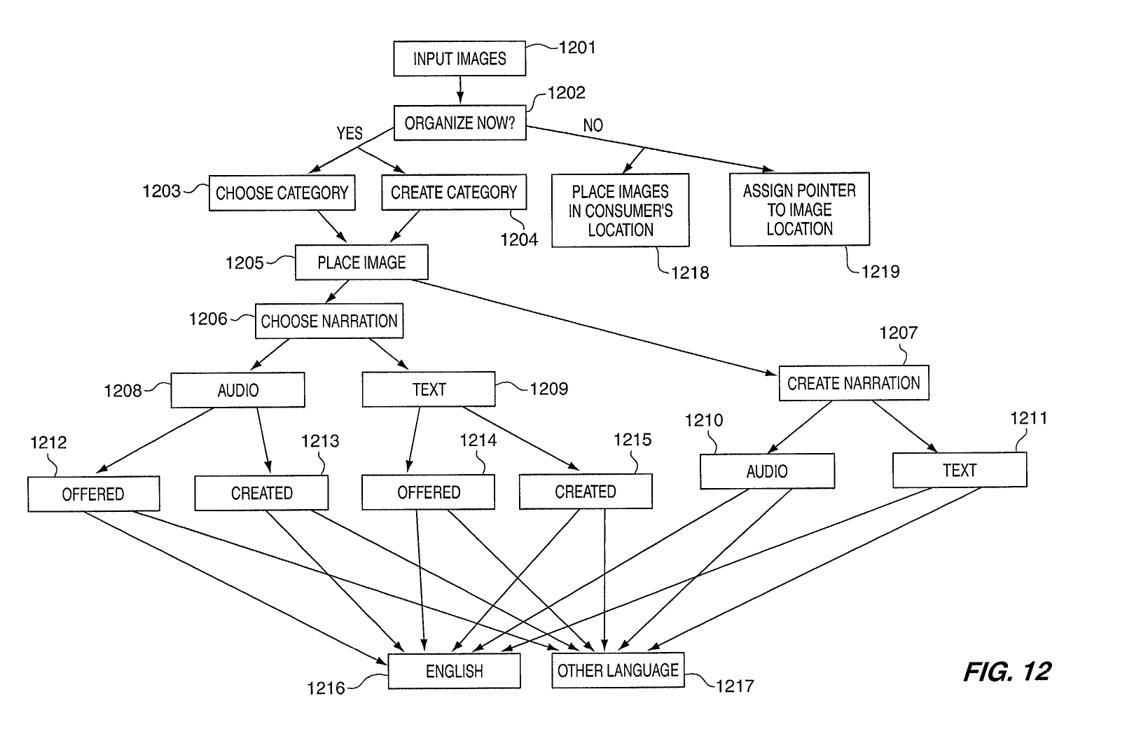

FIG. 12 illustrates in flow diagram form a conceptual overview of the typical operation of the memories product generation system 129A to enable the customer to characterize selected memories product(s), using a particular story theme as part of the organization of memories materials of step 205 of FIG. 2. At step 1201, the customer inputs memories materials, such as images, then has the option to organize these memories materials at step 1202. If not, the customer can place the memories materials in a memory, such as memories Materials Database 126, at step 1218 and assign a pointer to the memory storage location at 1219 at which these memories materials are stored. If the customer elects to organize the memories materials, then at step 1203/1204 the customer can choose/create a category for the memories materials. The selected category is associated with the memories materials for future use by the automated memories product generator 153. The customer can place the memories materials at step 1205 in a virtual memories product(s) and create associated narration at step 1207, with the narration being audio 1210 and/or textual 1211 in nature and optionally translated/stored in English 1216 or another selected language 1217. The customer can alternatively choose existing narration at step 1206, which can be audio 1208 and/or textual 1209. Each of these choices further provide the customer with the option of integrating segments of offered 1212/1214 content and/or customer created content 1213/1215, all of which can be optionally translated/stored in English 1216 or another selected language 1217.

Image Organization

The automated memories product generator 153 of the memories product generation system 129A typically prompts the customer with questions as the customer organizes the images. The combination of the customer's actions in organizing and annotating the images and answers to the questions produce a perspective of the customer's interests. Thus, the automated memories product generator 153 can use various tools to effect the memories materials management, including standard templates for various memories products, or the use of neuromorphic processing to provide an expert system view of the memories materials. Typically, the more sophisticated the memories product, the more sophisticated the implementation of the automated memories product generator 153. The customer input regarding a time stamp for the memories materials and descriptive information that characterizes the memories materials is important to enable the automated memories product generator 153 to process the memories materials in a meaningful manner.

Further images can be added by the operation of option button 810, which causes the process to return to step 204 where the customer is prompted to input additional memories materials. The customer can also preview the images that are created by operating button option 811, as is described below. The customer is also provided with the standard “Help” option button 806 to enable the customer to obtain on-line assistance, a list of frequently asked questions and any other pertinent topics related to this page and the opportunity to perform a word search of any of the topics listed in the help library. By definition, a single image would make at least one product. The customer is dynamically advised of product choices available as the image count increases. The product output is quite dynamic, so the customer will not be advised prior to creating the memories product(s) how many images are required for each memories product. The options: Organize Images 807, Capture Memory 808, Choose Product 809 are also presented on screen display 800, as described above with respect to FIG. 6.

The memories product generation process advances to step 206 where the customer is presented with screen display 900 to enable the customer to, once a predetermined quantity of memories materials are available, view a proposed memories product that has been generated by the automated memories product generator 153 of the memories product generation system 129A, with the background being determined by story type and style selected by customer, with the sequence of the memories materials in the memories product typically being a temporal sequence, or other sequence selected by the customer. The memories materials can be ordered by means of a time line or other ordering algorithm. Imagegraphs can be organized into multiple products since the topic can be an album, a calendar, e-cards, postcards, frameables, prints and so on. The memories product generation system 129A presents the customer with a listing of the various memories products that can be generated from the available memories materials.

Memories Product Customization

In FIG. 9, these memories products are listed as items 901A-901H, but are not limited to these choices, since other memories products can be created. The system can input captions either outside of the image field or within the image field using dialoging type of graphics. Optional sentiment can be provided, either automatically generated by the automated memories product generator 153, or customer generated. In addition, multiple memories products can be simultaneously generated from the source memories materials.

The customer can proceed with the next step 207 of the process by clicking on the “NEXT” button option 902. The customer is also provided with the standard “Help” option button 906 to enable the customer to obtain on-line assistance, a list of frequently asked questions and any other pertinent topics related to this page and the opportunity to perform a word search of any of the topics listed in the help library. The options: Organize Images 907, Capture Memory 908, Choose Product 909 are also presented on screen display 900 and are described above with respect to FIG. 6.

Memories Product Preview

The memories product generation process advances to step 207 where the customer is presented with workspace 1000 to enable the customer to preview the generated virtual memories product and edit the virtual memories product. The customer can activate the edit operation by activating the option button 1002. The display screen 1003 presents the customer with a view of the memories product, consisting of images 1004A-1004C and captions 1005A-1005B. Multiple virtual memories products can be displayed. The customer can retrace their navigation of this site by activating the “Previous Page” button option 1010A or proceed with the next step of the memories product generation process by activating the “Next Page” option button 1010B to proceed to step 208, where the customer can purchase the memories product. The customer is also provided with the standard “Help” option button 1006 to enable the customer to obtain on-line assistance, a list of frequently asked questions and any other pertinent topics related to this page and the opportunity to perform a word search of any of the topics listed in the help library. The options: Organize Images 1007, Capture Memory 1008, Choose Product 1009 are also presented on screen display 1000, as described above with respect to FIG. 6.

The memories product generation process advances to step 208 where the customer is presented with screen display (not shown) to enable the customer to purchase a memories product via the product ordering system 127, as is well known in this technology, for one or more recipients (including the customer) designated by the customer.

Save As You Go

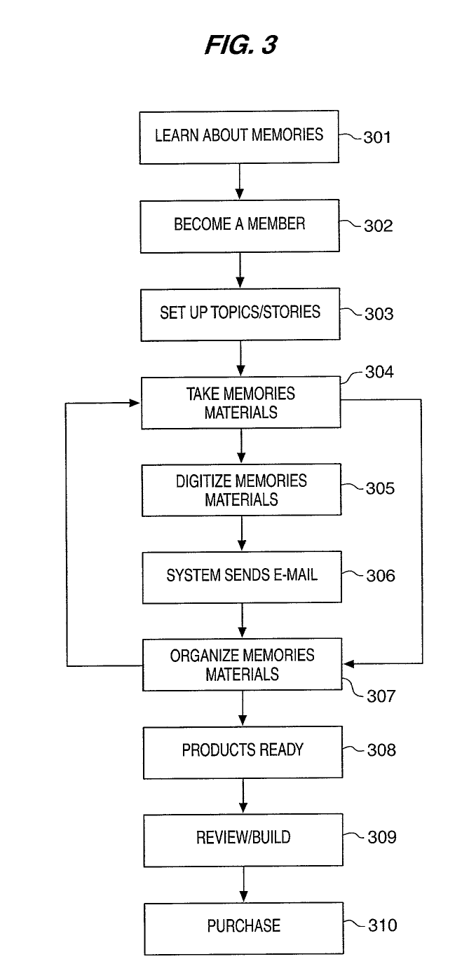

FIG. 3 illustrates a memories product generation process that is analogous to the memories product generation process of FIG. 2, with steps 301-303 of FIG. 3 being the same as steps 201-203 of FIG. 2 as described above. However, at step 304, the customer takes memories materials and transmits these memories materials to a remote site or inputs other memories materials at a remote site, such as external site 130 in FIG. 1A. In the case of images (such as photographs), the remote site 130 digitizes the images at step 305, transmits a message to the memories product generation system 129A at step 306 indicative of the completion of the processing of additional memories materials, and the memories product generation system 129A then transmits an e-mail message to the customer to advise the customer that additional memories materials have been received. In addition, the memories materials can be submitted by multiple individuals and managed and processed by the customer. The remaining steps 307-310 are the same as steps 205-208 as described above with respect to FIG. 2.

Event Driven

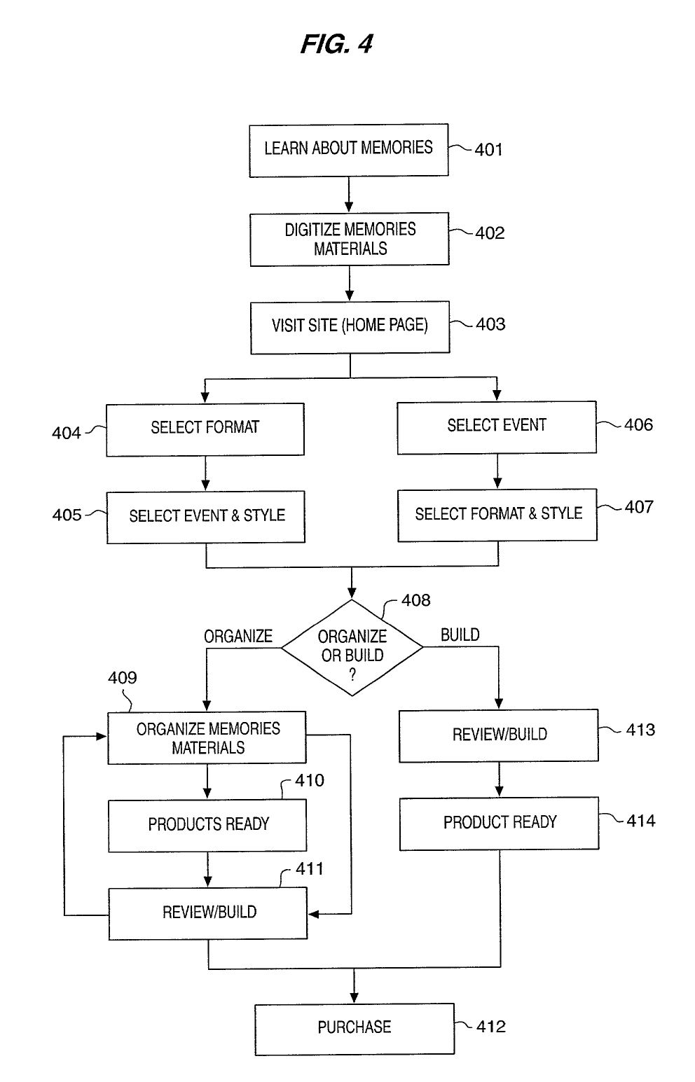

FIG. 4 illustrates the memories product generation process where the customer decides to create a memories product for a predetermined event, rather than participate in an ongoing memories materials collection process as is shown in FIGS. 2 and 3. At step 401, the customer, once connected to the memories product generation system 129A, receives an initial screen display 500, such as that shown in FIG. 5. This screen display 500 provides the customer with a number of options, as a function of the customer's familiarity with the memories product generation system 129A and whether the customer is a registered customer of memories product generation system 129A. If the customer is a registered customer, then the customer can provide their Customer ID in field 501 and their Password in field 502 to register with the memories product generation system 129A. In response to the data input in fields 501, 502, the memories product generation system 129A compares the data entries with the list of registered customers stored in Database B, the Users Database 124 and performs a standard customer authentication process to thereby enable the customer to proceed with the memories product generation. The authenticated customer can select from a number of options presented on screen display 500, such as Organize Images 507, Capture Memory 508, Choose Product 509, which options are described above with respect to FIG. 6.

However, for the sake of illustration, assume that this customer is a subscriber to the memories product generation system 129A then the customer can provide their Customer ID in field 501 and their Password in field 502 to register with the memories product generation system 129A. In response to the data input in fields 501, 502, the memories product generation system 129A compares the data entries with the list of registered customers stored in Database B, the Users Database 124 and performs a standard customer authentication process to thereby enable the customer to proceed with the memories product generation. The authenticated customer can select from a number of options presented on screen display 500, such as Organize Images 507, Capture Memory 508, Choose Product 509, which options are described above with respect to FIG. 6 above.

At step 402, the customer uploads memories materials, such as digital/digitized images or memories materials input via scanner S1, digital camera S2, a microphone S3 for voice input (or phone) or a digital video camera S4 attached to the terminal device T1. The memories materials can also be linked to the memories product generation system 129A from an external database, either at the present time or as generated and stored in the external source. The customer manages the memories materials portfolio by parsing the set of memories materials into at least one story and associates the story with a corresponding topic of interest.

At step 403 the customer visits the WEB site that contains the memories product generation system 129A to thereby create the memories product. The customer now has two options to create the memories product(s). The customer can select a memories product and a particular format for the memories product, then customize the format for a particular event and recipient style, or can select the event, followed by the format of the memories product(s) and the recipients style. In either case, the customer is presented at steps 404-407 with screen displays to guide them through the process. For example, at step 406, screen display 700 enables the customer to set up topic of interest, with a style for each of the plurality of topics. The screen display 700 provides the customer with a number of options: the customer selects a topic from the list of standard topics presented in list display 701. Each topic selected by the customer activating option button “ADD” 703 is displayed in field 705 to thereby enable the customer to view the collection of topics selected. In this example, the customer has selected three topics: family's year, millennium year, xmas traditions. The customer can also select a style from the list of styles displayed in field 702 and the memories product generation system 129A automatically selects titles, borders, backgrounds, graphics, stories and placement of memories materials. The memories product generation system 129A selects number of memories materials per frame/page and can suggest how many memories products can be produced from the collection. The product can include animation within the memory frame and/or between media frames. The customer can retrace their navigation of this site from screen display 700 by activating the “BACK” button option 710A or proceed with the next step of the memories product generation process by activating the “NEXT” option button 710B to proceed to step 408, where the customer digitizes memories materials. The customer is also provided with the standard “Help” option button 706 to enable the customer to obtain on-line assistance, a list of frequently asked questions and any other pertinent topics related to this page and the opportunity to perform a word search of any of the topics listed in the help library. The options: Organize Images 707, Capture Memory 708, Choose Product 709 are also presented on screen display 700 and are described above with respect to FIG. 6.

At step 408 the customer is provided with the option to proceed directly to memories product selection (steps 413-414) or to provide memories product design and management (steps 409-411).

At step 409, the customer can organize the memories materials using the screen display 800 as shown on FIG. 8. Each memories material is displayed seriatim in display field 803 and the customer has control of editing the display via the capabilities provided in lists 801 and 802, where the customer can “Rotate”, “Edit”, “Zoom”, “Clean-Up”, or crop the image using various shapes and aspect ratios. The customer can also create or edit a caption via data entry field 804. The topic and story are selected via fields 805A, 805B, respectively.

The memories product can comprise a product that morphs as a function of the recipient's identity. Each page can represent a period of time, a specific event, specific individuals or any combination thereof. The recipient's profile can be stored or accessed from a remote site. The customer's profile can be dynamically and passively determined or can be crafted via the use of psychographic questions to automatically populate the customer's profile and thence the resulting memories product. The memories product can be in any media and any format, either printed, or electronic in form. The memories product generation system 129A automatically integrates various artifacts into various personalized products. The memories product generation system 129A prompts the customer with questions as the customer organizes the images. The combination of the customer's actions in organizing the images and answers to the questions produce a perspective of the customer's interests. Further images can be added by the operation of option button 810, which returns to step 204 in FIG. 2 where the customer can input additional memories materials. The customer can also preview the images that are created by operating button option 811, as is described below. The customer is also provided with the standard “Help” option button 806 to enable the customer to obtain on-line assistance, a list of frequently asked questions and any other pertinent topics related to this page and the opportunity to perform a word search of any of the topics listed in the help library. The options: Organize Images 807, Capture Memory 808, Choose Product 809 are also presented on screen display 800 and are described above with respect to FIG. 6.

The memories product generation process advances to step 410 where the customer is presented with screen display 900 to enable the customer to, once a predetermined quantity of memories materials are available, view a proposed memories product that has been generated by the automated memories product generator 153 of the memories product generation system 129A, with the background being determined by story type and style selected by customer, with the sequence of the memories materials in the memories product typically being a temporal sequence, or other sequence selected by the customer. The memories materials can be ordered by means of a time line or any other ordering algorithm. Imagegraphs can be organized into multiple products since the topic can be an album, a calendar, e-cards, postcards, frameables, prints and so on. The memories product generation system 129A presents the customer with a listing of the various memories products that can be generated from the available memories materials. In FIG. 9, these memories products are listed as items 901A-901H. The system can input captions either outside of the image field or within the image field using dialoging type of graphics. Optional sentiment provided, either automatically generated or customer generated or edited multiple memories products can be simultaneously generated from the source memories materials. The customer can proceed with the next step 411 in FIG. 4 of the process by clicking on the “NEXT” button option 902. The customer is also provided with the standard “Help” option button 906 to enable the customer to obtain on-line assistance, a list of frequently asked questions and any other pertinent topics related to this page and the opportunity to perform a word search of any of the topics listed in the help library. The options: Organize Images 907, Capture Memory 908, Choose Product 909 are also presented on screen display 900 as described above with respect to FIG. 6.

The memories product generation process advances to step 411 where the customer is presented with screen display 1000 to enable the customer to preview the generated memories product and edit the memories product. The customer can activate the edit operation by activating the option button 1002. The display screen 1003 presents the customer with a view of the memories product, consisting of images 1004A-1004C and captions 1005A-1005B. The customer can retrace their navigation of this site by activating the “Previous Page” button option 1010A or proceed with the next step of the memories product generation process by activating the “Next Page” option button 1010B to proceed to step 412 in FIG. 4, where the customer can purchase the memories product. The customer is also provided with the standard “Help” option button 1006 to enable the customer to obtain on-line assistance, a list of frequently asked questions and any other pertinent topics related to this page and the opportunity to perform a word search of any of the topics listed in the help library. The options: Organize Images 1007, Capture Memory 1008, Choose Product 1009 are also presented on screen display 1000 as described above with respect to FIG. 6.

The memories product generation process advances to step 412 where the customer is presented with screen display (not shown) to enable the customer to purchase a memories product for one or more recipients (including the customer) as designated by the customer.

Multiple Party Collaboration

The memories product generation system 129A is described above as hosting an interaction with a single customer. However, the memories product generation system 129A can obtain input from a plurality of individuals. As the virtual memories product(s) are created by the automated memories product generator 153, the customer can authorize other individuals to access these virtual memories product(s) via their terminal devices, to thereby obtain their contributions, which can include the addition of memories materials to the Memories Materials Database 126 or other creative input as described above. The access is typically seriatim, in that a virtual memories product can be routed among a plurality of individuals in a predefined order to obtain input from all of these individuals, although other routing schemes and contribution collection can be supported by the automated memories product generator 153.

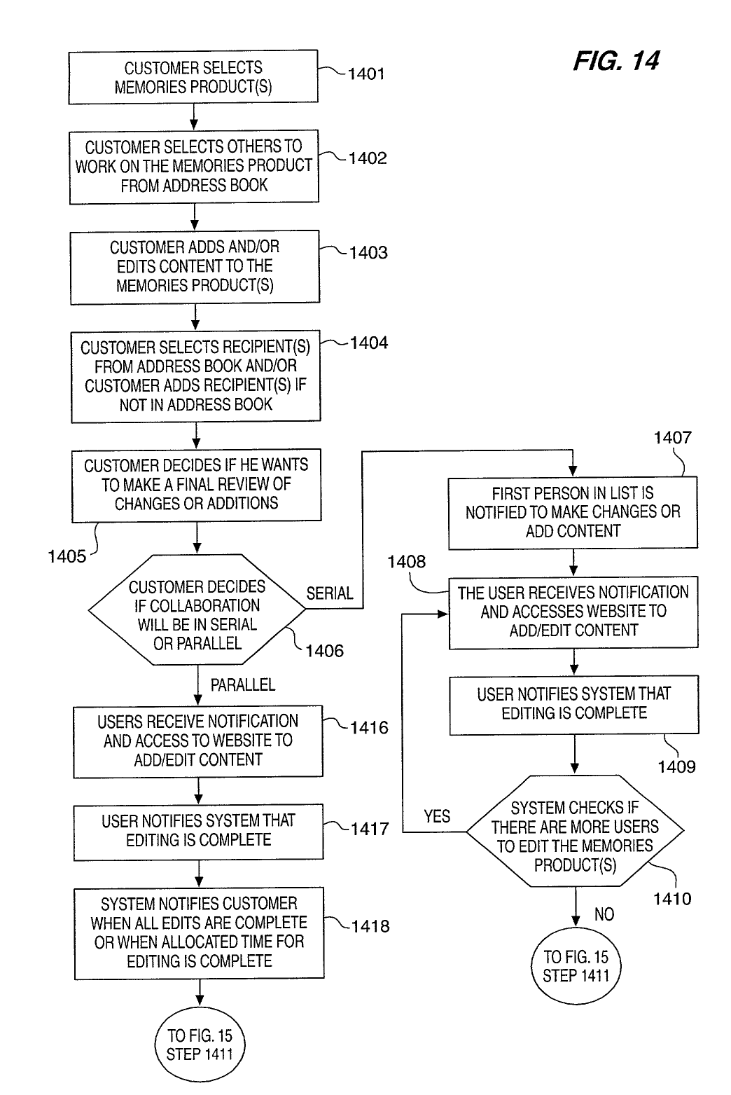

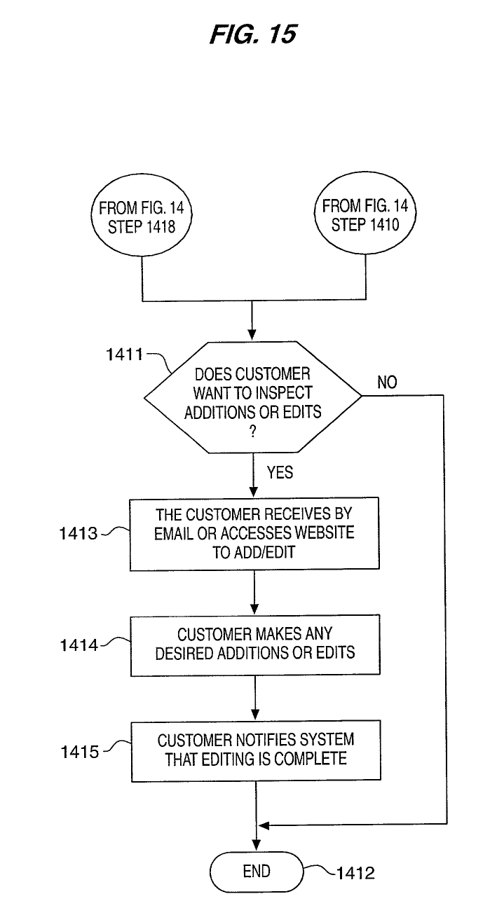

FIGS. 14 and 15 illustrate in flow diagram form the operation of the present memories product generation system in routing a virtual memories product to at least one individual other than the customer for review, editing and approval. At step 1401, the customer, as part of the above described process, selects a virtual memories product(s) and at step 1402 selects one or more individuals from the customer's address book, or inputs the names of individual(s) who are selected to work on the virtual memories product(s). At step 1403, the customer adds and/or edits the content of the virtual memories product(s) and when the virtual memories product(s) are completed, the customer at step 1404 selects one or more recipients from the customer's address book, and/or inputs data that identifies the recipient(s). At step 1405, the customer determines whether they wish to make the final review of the virtual memories product(s) prior to these virtual memories product(s) being implemented by the production system 128 as memories product(s) and shipped to the identified recipient(s). At step 1406, the customer decides whether the collaboration of the other individuals will be in serial or parallel form. If in serial form, then at step 1407 the first individual on the customer's routing list is notified of the availability off the virtual memories product(s) for review and editing. This individual can access the memories product generation system 129A as described above at step 1408 to add content and/or edit the existing content of the virtual memories product(s). Once the individual notifies the memories product generation system 129A at step 1409 or a predetermined amount of time has elapsed, the memories product generation system 129A determines at step 1410 whether additional individuals remain on the routing list who have not yet accessed the virtual memories product(s). If so, processing returns to step 1408 as described above and the next successive individual on the routing list is notified and can access the virtual memories product(s) for review and/or editing, and if not, processing advances to step 1411 where the memories product generation system 129A determines whether the customer wishes a final review of the virtual memories product(s). If not, processing exits at step 1411 to the production system 120 to produce the memories product(s) from the virtual memories product(s). If the customer has elected to provide a final review of the virtual memories product(s), processing at step 1411 advances to step 1413 where the customer is notified that the review(s) of the virtual memories product(s) are completed and the customer can access the virtual memories product(s) for a final review. At step 1414 the customer performs the final review/editing and at step 1415 indicates to the memories product generation system 129a that the virtual memories product(s) are ready for production, at which time the process exits at step 1412 to the production system 128.

If at step 1406 the customer had indicated a parallel collaboration, then the process would branch to step 1416 where all of the individuals are notified of the availability off the virtual memories product(s) for review and editing. These individuals can access the memories product generation system 129A as described above at step 1416 to add content and/or edit the existing content of the virtual memories product(s). Once the individuals notify the memories product generation system 129A at step 1417, or a predetermined amount of time has elapsed, the memories product generation system 129A notifies the customer that the review is completed and processing advances to step 1411 as described above.

Product Chaining

The virtual memories product(s) produced by the automated memories product generator 153 can be stored by the customer in the Memories Materials Database 126 for future use. One future use of such virtual memories product(s) is for this data to be input into the design of other memories product(s) or future memories product(s). The use of the virtual memories product(s) for such a purpose expedites the design of other related virtual memories products so the customer can maintain a consistent theme or provide a series of memories products that follow a predetermined theme or are representative of a timewise progression of memories relating to an individual or theme.

SUMMARY

The memories product generation system provides a customer with the capability to input and edit various memories materials for use in generating memories products. The customer also defines at least one topic that is used to organize the received memories materials and at least one “story”, which consists of a recipient's point of view of or interest in the memories materials. The memories product generation system then automatically organizes the received memories materials and integrates these materials with finishing touches.

What is claimed:

1. A memories product generation system for automatically generating a memories product, said memories product being customized for at least one of a customer and a recipient, said memories product generation system comprising:
means for inputting a plurality of memories materials, each of which comprises data that represents a display object;
means for providing a customer with an interface to define at least one topic for said memories product;
means for storing data that identifies at least one of a customer and a recipient who is to receive said memories product; and
means for automatically generating at least one memories product, that comprises a plurality of display objects formed from said memories materials, said at least one memories product being in a form and content that is customized for said at least one of a customer and a recipient.

2. The memories product generation system of claim 1 wherein said means for inputting a plurality of memories materials comprises:
means for digitizing at least one image; and
means for uploading said at least one digitized image to a memory.

3. The memories product generation system of claim 2 wherein said memory is located remotely from said means for automatically generating, said means for inputting a plurality of memories materials further comprises:
means for transmitting said at least one digitized image to a memory collocated with said means for automatically generating via a communication medium that interconnects said remotely located memory with said means for automatically generating.

4. The memories product generation system of claim 1 wherein said means for inputting a plurality of memories materials comprises:
means for accessing a memory that stores a plurality of memories materials; and
means for uploading at least one of said plurality of memories materials via a communication medium.

5. The memories product generation system of claim 1 wherein said means for providing a customer with an interface comprises:
means for retrieving at least one of recipient and customer characteristic data from said customer via a series of queries presented to said customer via at least one display screen.

6. The memories product generation system of claim 5 wherein said means for providing a customer with an interface further comprises:
means for storing said characteristic data in a memory.

7. The memories product generation system of claim 5 wherein said means for providing a customer with an interface further comprises:
means for retrieving said characteristic data from a memory located remote from said means for automatically generating in response to said customer identifying said memory.

8. The memories product generation system of claim 1 wherein said memories product contains at least one page, said means for automatically generating comprises:
means for producing a layout for said page of said memories product, said page layout comprising a plurality of display objects, each display object having a plurality of characteristics which define a content of an image created from said display object and a locus of said image created from said display object on said page.

9. The memories product generation system of claim 8 further comprising:
means for enabling said customer to manipulate said display objects, including at least one of the display object manipulation functions of: crop, rotate, size, reposition, enlarge, and the like.

10. The memories product generation system of claim 9 further comprising:
means for automatically selecting at least one display attribute for said page excluding said display images, from the class of display attributes including: titles, borders, backgrounds, graphics, stories and placement of memories materials.

11. The memories product generation system of claim 1 wherein said means for automatically generating comprises:
means for automatically generating at least one virtual memories product, that comprises a plurality of display objects formed from said memories materials and viewable in electronic form by said customer.

12. The memories product generation system of claim 11 wherein said means for automatically generating further comprises:
means for enabling said customer to edit said at least one virtual memories product.

13. The memories product generation system of claim 12 wherein said means for automatically generating further comprises:
means for enabling said customer to store said at least one virtual memories product in memory.

14. The memories product generation system of claim 13 wherein said means for automatically generating further comprises:
means for retrieving said stored virtual memories product from said memory; and
means for enabling said customer to edit said retrieved virtual memories product to create another virtual memories product.

15. The memories product generation system of claim 11 further comprising:
means for routing said at least one virtual memories product, viewable in electronic form, to at least one individual other than said customer.

16. The memories product generation system of claim 15 wherein said means for automatically generating further comprises:
means for enabling said at least one individual to edit said at least one virtual memories product.

17. The memories product generation system of claim 11 wherein said means for automatically generating further comprises:
means for enabling said customer to initiate production of said at least one memories product from said at least one virtual memories product.

18. The memories product generation system of claim 1 wherein said means for automatically generating comprises:
means for correlating a topic selected by said customer with said memories materials and said data that identifies at least one of a customer and a recipient who is to receive said memories product to automatically select a plurality of memories materials for inclusion in said at least one memories product.

19. The memories product generation system of claim 18 wherein said means for automatically generating further comprises:
means for automatically formatting said selected plurality of memories materials into at least one virtual memories product, that comprises a plurality of display objects formed from said memories materials and viewable in electronic form by said customer.

20. The memories product generation system of claim 19 wherein said means for automatically generating further comprises:
means for enabling said customer to edit said at least one virtual memories product.

21. The memories product generation system of claim 20 wherein said means for automatically generating further comprises:
means for enabling said customer to store said at least one virtual memories product in memory.

22. The memories product generation system of claim 21 wherein said means for automatically generating further comprises:
means for retrieving said stored virtual memories product from said memory; and
means for enabling said customer to edit said retrieved virtual memories product to create another virtual memories product.

23. The memories product generation system of claim 21 wherein said means for automatically generating further comprises:
means for enabling said customer to initiate production of said at least one memories product from said at least one virtual memories product.

24. A method for automatically generating a memories product, said memories product being customized for at least one of a customer and a recipient, said method for automatically generating a memories product comprising the steps of:
inputting a plurality of memories materials, each of which comprises data that represents a display object;
providing a customer with an interface to define at least one topic for said memories product;
storing data that identifies at least one of a customer and a recipient who is to receive said memories product; and
automatically generating at least one memories product at a memories product output device, that comprises a plurality of display objects formed from said memories materials, said at least one memories product being in a form and content that is customized for said at least one of a customer and a recipient.

25. The method for automatically generating a memories product of claim 24 wherein said step of inputting a plurality of memories materials comprises:
digitizing at least one image; and
uploading said at least one digitized image to a memory.

26. The method for automatically generating a memories product of claim 25 wherein said memory is located remotely from said memories product output device, said step of inputting a plurality of memories materials further comprises:
transmitting said at least one digitized image to a memory collocated with said memories product output device via a communication medium that interconnects said remotely located memory with said memories product output device.

27. The method for automatically generating a memories product of claim 24 wherein said step of inputting a plurality of memories materials comprises:
accessing a memory that stores a plurality of memories materials; and
uploading at least one of said plurality of memories materials via a communication medium.

28. The method for automatically generating a memories product of claim 24 wherein said step of providing a customer with an interface comprises:
retrieving at least one of recipient and customer characteristic data from said customer via a series of queries presented to said customer via at least one display screen.

29. The method for automatically generating a memories product of claim 28 wherein said step of providing a customer with an interface further comprises:
storing said characteristic data in a memory.

30. The method for automatically generating a memories product of claim 28 wherein said step of providing a customer with an interface further comprises:
retrieving said characteristic data from a memory located remote from said memories product output device in response to said customer identifying said memory.

31. The method for automatically generating a memories product of claim 24 wherein said memories product contains at least one page, said step of automatically generating comprises:
producing a layout for said page of said memories product, said page layout comprising a plurality of display objects, each display object having a plurality of characteristics which define a content of an image created from said display object and a locus of said image created from said display object on said page.

32. The method for automatically generating a memories product of claim 31 further comprising the step of:
enabling said customer to manipulate said display objects, including at least one of the display object manipulation functions of: crop, rotate, size, reposition, enlarge, and the like.

33. The method for automatically generating a memories product of claim 32 further comprising the step of:
automatically selecting at least one display attribute for said page excluding said display images, from the class of display attributes including: titles, borders, backgrounds, graphics, stories and placement of memories materials.

34. The method for automatically generating a memories product of claim 24 wherein said step of automatically generating comprises:
automatically generating at least one virtual memories product, that comprises a plurality of display objects formed from said memories materials and viewable in electronic form by said customer.

35. The method for automatically generating a memories product of claim 34 wherein said step of automatically generating further comprises:
enabling said customer to edit said at least one virtual memories product.

36. The method for automatically generating a memories product of claim 35 wherein said step of automatically generating further comprises:
enabling said customer to store said at least one virtual memories product in memory.

37. The method for automatically generating a memories product of claim 36 wherein said step of automatically generating further comprises:
retrieving said stored virtual memories product from said memory; and
enabling said customer to edit said retrieved virtual memories product to create another virtual memories product.

38. The method for automatically generating a memories product of claim 34 further comprising the step of:
routing said at least one virtual memories product, viewable in electronic form, to at least one individual other than said customer.

39. The method for automatically generating a memories product of claim 38 wherein said step of automatically generating further comprises:
enabling said at least one individual to edit said at least one virtual memories product.

40. The method for automatically generating a memories product of claim 34 wherein said step of automatically generating further comprises:
enabling said customer to initiate production of said at least one memories product from said at least one virtual memories product.

41. The method for automatically generating a memories product of claim 24 wherein said step of automatically generating comprises:
correlating a topic selected by said customer with said memories materials and said data that identifies at least one of a customer and a recipient who is to receive said memories product to automatically select a plurality of memories materials for inclusion in said at least one memories product.

42. The method for automatically generating a memories product of claim 41 wherein said step of automatically generating further comprises:
automatically formatting said selected plurality of memories materials into at least one virtual memories product, that comprises a plurality of display objects formed from said memories materials and viewable in electronic form by said customer.

43. The method for automatically generating a memories product of claim 42 wherein said step of automatically generating further comprises:
enabling said customer to edit said at least one virtual memories product.

44. The method for automatically generating a memories product of claim 43 wherein said step of automatically generating further comprises:
enabling said customer to store said at least one virtual memories product in memory.

45. The method for automatically generating a memories product of claim 44 wherein said step of automatically generating further comprises:
retrieving said stored virtual memories product from said memory; and
enabling said customer to edit said retrieved virtual memories product to create another virtual memories product.

46. The method for automatically generating a memories product of claim 44 wherein said step of automatically generating further comprises:
enabling said customer to initiate production of said at least one memories product from said at least one virtual memories product.

47. A memories product generation system for automatically generating a memories product, said memories product being customized for at least one of a customer and a recipient, said memories product generation system comprising:
memories materials input means for inputting a plurality of memories materials, each of which comprises data that represents a display object;
customer interface means for providing a customer with an interface to define at least one topic for said memories product;
memory means for storing data that identifies at least one of a customer and a recipient who is to receive said memories product; and
automated memories product generation means for automatically generating at least one memories product, that comprises a plurality of display objects formed from said memories materials, said at least one memories product being in a form and content that is customized for said at least one of a customer and a recipient.

48. The memories product generation system of claim 47 wherein said memories materials input means comprises:
image input means for digitizing at least one image; and
communication means for uploading said at least one digitized image to a memory.

49. The memories product generation system of claim 48 wherein said memory is located remotely from said memories product generation means, said memories materials input means further comprises:
data communication means for transmitting said at least one digitized image to a memory collocated with said memories product generation means via a communication medium that interconnects said remotely located memory with said memories product generation means.

50. The memories product generation system of claim 47 wherein said memories materials input means comprises:
data communication means for accessing a memory that stores a plurality of memories materials; and
data retrieval means for uploading at least one of said plurality of memories materials via a communication medium.

51. The memories product generation system of claim 47 wherein said customer interface means comprises:
profile means for retrieving at least one of recipient and customer characteristic data from said customer via a series of queries presented to said customer via at least one display screen.

52. The memories product generation system of claim 51 wherein said customer interface means further comprises:
database means for storing said characteristic data in a memory.

53. The memories product generation system of claim 51 wherein said customer interface means further comprises:
data retrieval means for retrieving said characteristic data from a memory located remote from said memories product generation means in response to said customer identifying said memory.

54. The memories product generation system of claim 47 wherein said memories product contains at least one page, said memories product generation means comprises:
layout means for producing a layout for said page of said memories product, said page layout comprising a plurality of display objects, each display object having a plurality of characteristics which define a content of an image created from said display object and a locus of said image created from said display object on said page.

55. The memories product generation system of claim 54 further comprising:
image editing means for enabling said customer to manipulate said display objects, including at least one of the display object manipulation functions of: crop, rotate, size, reposition, enlarge, and the like.

56. The memories product generation system of claim 55 further comprising:
display editing means for automatically selecting at least one display attribute for said page excluding said display images, from the class of display attributes including: titles, borders, backgrounds, graphics, stories and placement of memories materials.

57. The memories product generation system of claim 47 wherein said memories product generation means comprises:
automated layout means for automatically generating at least one virtual memories product, that comprises a plurality of display objects formed from said memories materials and viewable in electronic form by said customer.

58. The memories product generation system of claim 57 wherein said memories product generation means further comprises:
virtual memories product editing means for enabling said customer to edit said at least one virtual memories product.

59. The memories product generation system of claim 58 wherein said memories product generation means further comprises:
memories materials storage means for enabling said customer to store said at least one virtual memories product in memory.

60. The memories product generation system of claim 59 wherein said memories product generation means further comprises:
virtual memories product retrieval means for retrieving said stored virtual memories product from said memory; and
virtual memories product editing means for enabling said customer to edit said retrieved virtual memories product to create another virtual memories product.

61. The memories product generation system of claim 47 further comprising:
alternate access means for routing said at least one virtual memories product, viewable in electronic form, to at least one individual other than said customer.

62. The memories product generation system of claim 61 wherein said memories product generation means further comprises:
virtual memories product editing means for enabling said at least one individual to edit said at least one virtual memories product.

63. The memories product generation system of claim 57 wherein said memories product generation means further comprises:
memories production system means for enabling said customer to initiate production of said at least one memories product from said at least one virtual memories product.

64. The memories product generation system of claim 47 wherein said memories product generation means comprises:
profile means for correlating a topic selected by said customer with said memories materials and said data that identifies at least one of a customer and a recipient who is to receive said memories product to automatically select a plurality of memories materials for inclusion in said at least one memories product.

65. The memories product generation system of claim 64 wherein said memories product generation means further comprises:
automated layout means for automatically formatting said selected plurality of memories materials into at least one virtual memories product, that comprises a plurality of display objects formed from said memories materials and viewable in electronic form by said customer.

66. The memories product generation system of claim 65 wherein said memories product generation means further comprises:
virtual memories product editing means for enabling said customer to edit said at least one virtual memories product.

67. The memories product generation system of claim 66 wherein said memories product generation means further comprises:
memories materials storage means for enabling said customer to store said at least one virtual memories product in memory.

68. The memories product generation system of claim 67 wherein said memories product generation means further comprises:
virtual memories product retrieval means for retrieving said stored virtual memories product from said memory; and
virtual memories product editing means for enabling said customer to edit said retrieved virtual memories product to create another virtual memories product.

69. The memories product generation system of claim 67 wherein said memories product generation means further comprises:
production system means for enabling said customer to initiate production of said at least one memories product from said at least one virtual memories product.
